(19) United States
(12) Patent Application Publication
(10) Pub. No.: US 2012/0115104 A1
(43) Pub. Date: May 10, 2012

(54) MULTI-ROOTED TOOTH EXTRACTION DEVICE

(75) Inventor: Jiangming Li, Shijiazhuang (CN)

(73) Assignee: EMPIRE TECHNOLOGY DEVELOPMENT LLC, Wilmington, DE (US)

(21) Appl. No.: 13/255,066

(22) PCT Filed: Aug. 17, 2010
(86) PCT No.: PCT/CN10/76067

§ 371 Date: Sep. 6, 2011

(51) Int. Cl. A61C 3/02

(52) U.S. Cl. 433/144; 433/215

(57) ABSTRACT

A multi-rooted tooth extraction device can include a cutting tool that can be inserted between the roots of a tooth to be extracted. A bracing tool can be coupled to the cutting tool to brace against the crown and a pressure can be applied such that the tooth can be cut from the root to the crown. The separate pieces of the tooth can then be easily removed. The ability of the bracing tool to be decoupled from the cutting tool can allow for improved leverage and usability of the cutting tool while being inserted between the roots.

### BACKGROUND

A tooth extraction is a traumatic and painful dental procedure, and even more so when the tooth is a multi-rooted tooth. Tooth extractions are considered either simple or surgical. A simple extraction is performed on a tooth that can be seen in the mouth. Most simple tooth extractions can be done using an injection of a local anesthetic. In a simple extraction, the dental practitioner can grasp the tooth with forceps and loosen it by moving the forceps back and forth. Then the tooth can be pulled out using force. Sometimes the dentist will use a dental “elevator” to help loosen the tooth. A dental elevator is an instrument that fits between the tooth and the gum. Simple tooth extractions can be performed on single-root teeth, but may be difficult to perform on multi-rooted teeth due to the two roots being more difficult to loosen in the tooth socket.

Surgical tooth extraction involves teeth that cannot be seen easily in the mouth or for multi-rooted teeth, such as molars. Often, the tooth may have broken off at the gum line or may not have fully come in. To see and remove the tooth, the dental practitioner must cut and pull back the gums. Pulling back the gum “flap” provides access to remove bone and/or a piece of the tooth. Surgical tooth extractions commonly are done by oral surgeons. They are done with injections of local anesthesia, and/or conscious sedation. Patients with special medical conditions and young children may be given general anesthesia. In a surgical tooth extraction, the dental practitioner may cut an incision in the gum to reach the tooth. In some cases, the tooth may need to be cut into pieces to be removed.

Currently, in dental operations for extracting a multi-rooted tooth with a large bifurcation angle between the roots, which is not suitable for removal as a whole, a common practice is to split the roots before removal. There are two common methods for splitting the roots. The first method includes splitting a root by hammer and chisel. A chisel is wedged into the root section of a tooth by manual force. The approach is efficient, but the discomfort caused by the vibration can have negative impacts on patient psychologically, and can create obstacles for patients to accept future operations. In addition, the section of the tooth where the chisel is wedged is the alveolar area, which is a relative aseptic area inside mouth. Such practice is not aligned with the surgical principle of aseptic surgery. Tooth crumbs can penetrate deep into inner tissues. Also, hammering with large force can cause discomfort to a patent's joints, especially for an operation removing a multi-rooted tooth from the lower jaw.

The second method includes the use of high speed turbo grinding. The use of high speed turbo grinding has a lower efficiency than root splitting by the hammer and chisel method; however, the grinding procedure is more comfortable for patients. During the grinding procedure, there is no ideal solution for the disinfection of the dentist chair water line, which sprays a water mist for cooling the tooth being ground. There are two potential problems caused by the water mist sprayed: first, the water mist entering into soft tissues can cause subcutaneous emphysema or submucosal emphysema, and the probability of secondary infection is high; and second, the water mist mixed with oral blood can form an aerosol, which can contaminate operation room air and cause cross infection.

Current methods of extracting multi-rooted teeth need improvements so that the procedure is less traumatic. As such, there still remains a need for improved techniques and dental tools to facilitate extraction of multi-rooted teeth.

### SUMMARY

In one embodiment, a multi-rooted tooth extraction device (“extraction device”) can be prepared to have multiple components that can be used alone or in combination. Such an extraction device can include a cutting tool and a bracing tool that can be separated and/or combined for performing a dental procedure. The cutting tool can include an elongate member having: a cutting end; a first handle end opposite the cutting end; and a first pivot member between the cutting end and the handle end. The bracing tool can include an elongate member that is removably coupleable with the cutting tool through a coupling. This allows the cutting tool to be used independently for insertion between the roots of a multi-rooted tooth. The bracing tool can then be coupled to the cutting tool and used to brace the crown of the tooth so that the cutting tool can cut the tooth from the roots to the crown. Accordingly, the bracing member can include: a brace end; a second handle end opposite of the brace end; and a second pivot member configured to mate and pivot with the first pivot member.

In one aspect, the cutting tool can be a dental tooth cutting tool that includes: a cutting end having a sharp tip and a cutting blade on a tooth-facing surface and a blunt edge on a tissue-facing surface opposite of the tooth-facing surface; a first handle end opposite of the cutting end; a first pivot member between the cutting end and the handle end, said first pivot member being configured to mate with and couple to a second pivot member of a dental bracing tool; and a first mating surface having a shape to conform with a second mating surface of the dental bracing tool.

In one aspect, the bracing tool can be a dental tooth bracing tool that includes: a brace end having a brace member configured to brace against a crown of a tooth to be cut; a handle end opposite of the brace end; and a first pivot member between the brace end and the handle end, said first pivot member configured to mate and pivot with a second pivot member of a dental tooth cutting tool; and a first mating surface having a shape to conform with a second mating surface of the dental tooth cutting tool.

In one aspect, a multi-rooted tooth extraction device can include a cutting member and a bracing member. The cutting member can include: a cutting end having a cutting edge configured to fit between roots of a multi-rooted tooth and cut the tooth from root to crown; a first handle end opposite of the cutting end and having a grip configured to be gripped by a practitioner; and a first pivot member between the cutting end and the handle end. The bracing member can be configured to be removably coupleable with the cutting member, and to pivot with respect to the cutting member when coupled thereto such that the cutting member and bracing member form an open orientation and a closed orientation. The transition from the open orientation to the closed orientation can facilitate cutting the tooth from root to crown. The bracing member can include: a brace end having a tooth brace configured to brace a crown of the tooth when the bracing member is coupled to the cutting member in the open orientation with the cutting end inserted between the roots, when in the closed orientation the brace end receives the cutting end; a second handle end opposite of the brace end and having a grip configured to be gripped by the practitioner, the second handle end being configured to receive the first handle end when in the closed orientation; and a second pivot member configured to mate with the first pivot member so as to removably couple the bracing member with the cutting member and allow the cutting member to pivot with respect to the bracing member.

The dental tools can be used in a method of extracting a multi-rooted tooth. Such a method can include providing a multi-rooted tooth extraction device that includes a cutting member and a bracing member; inserting the cutting member between roots of a multi-rooted tooth; coupling the bracing member with the cutting member; bracing the bracing member against a crown of the tooth; and cutting the tooth with the cutting member from the root to the crown. This can split the tooth into two pieces for easy withdrawal from the tooth socket, and each piece can be extracted similar to the less invasive simple root extraction technique.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1A is an illustration of an embodiment of a multi-rooted tooth extraction device.

FIG. 1B is an illustration of an embodiment of a cutting tool that couples with a bracing tool to form the multi-rooted tooth extraction device of FIG. 1A.

FIG. 1C is an illustration of an embodiment of a bracing tool that couples with the cutting tool of FIG. 1B in order to form the multi-rooted extraction device of FIG. 1A.

FIGS. 2A-2C are illustrations of different embodiments of bracing ends of a bracing tool.

FIG. 3A is an illustration of an embodiment of a method of inserting the cutting tool of FIG. 1B between the roots of a multi-rooted tooth.

FIG. 3B is an illustration of an embodiment of a method of coupling the bracing tool of FIG. 1B with the cutting tool of FIG. 1C to form the multi-rooted tooth extraction device of FIG. 1A to cut the tooth of FIG. 3A and split the tooth from root to crown.

### DETAILED DESCRIPTION

The following description sets forth various examples along with specific details to provide a thorough understanding of claimed subject matter. It will be understood by those skilled in the art, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

Generally, a multi-rooted tooth extraction device (“extraction device”) can include a cutting member and a bracing member that can be separated and/or combined for performing a dental procedure. In some instances the cutting member and bracing member are coupled end-to-end from the handles so that the members are retained together, and can further be coupled at pivot members to allow for the extraction procedure to be performed as described herein. The coupling of cutting and bracing members can be via a strap, tether, or other feature that can couple the handles of the cutting and bracing members so that they can be coupled and decoupled at the pivot points as described herein. In other instances, the cutting member is a separate cutting tool apart from the bracing member which is a separate bracing tool. These separate tools can be coupled together at pivot members for use as described herein. In any configuration, the cutting member includes a cutting end that is not associated with the brace end of the bracing member so that the cutting end can be inserted between two roots without the bracing member getting in the way. After proper placement of the cutting end between the roots, the bracing member can be coupled to the cutting member and the brace end can be positioned to brace against the crown of the tooth.

In some examples, a cutting member can be a portion of an extraction device that has cutting features such as, but not limited to, a sharp tip and a cutting end. A cutting member may be integrated, attached, fastened, or otherwise permanently or removably coupled with a bracing member. Alternative, a cutting member may be considered to be a cutting tool. A cutting tool can be a separate and distinct tool that is removably coupleable with the bracing member or bracing tool to form the extraction device. The features of the cutting members and cutting tools as described herein may be included together and used for any embodiment of a cutting member or tool.

In some examples, a bracing member can be a portion of an extraction device that has brace features such as the brace end or brace members. A bracing member may be integrated, attached, fastened, or otherwise permanently or removably coupled with a cutting member or cutting tool. Alternative, a bracing member may be considered to be a bracing tool. A bracing tool can be considered to be a separate and distinct tool that is removably coupleable with the cutting member or cutting tool to form the extraction device. The features of the bracing members and bracing tools as described herein may be included together and used for any embodiment of a bracing member or tool.

The cutting member can include an elongate member having: a cutting end; a first handle end opposite the cutting end; and a first pivot member between the cutting end and the handle end. The bracing member can include an elongate member that is removably coupleable with the cutting member through a coupling. This allows the cutting member to be used independently for insertion between the roots of a multi-rooted tooth. The bracing member can then be coupled to the cutting member and used to brace the crown of the tooth so that the cutting member can cut the tooth from the roots to the crown. Accordingly, the bracing member can include: a brace end; a second handle end opposite of the brace end; and a second pivot member configured to mate and pivot with the first pivot member of the cutting member.

In one aspect, the cutting member can be a discrete dental tooth cutting tool that includes a cutting end, a first handle end, and a first pivot member. The cutting end can include a sharp tip and a cutting blade on a tooth-facing surface, and can have a blunt edge on a tissue-facing surface opposite the tooth-facing surface. The first handle end may be opposite the cutting end. The first pivot member may be located between the cutting end and the first handle end, and the first pivot member can be configured to mate with and couple to a second pivot member of the bracing member/tool. Also, the first mating surface of the cutting member/tool can have a shape that conforms to a second mating surface of the bracing member/tool.

In one aspect, the bracing member can be a discrete dental tooth bracing tool that includes a brace end, a second handle (e.g., brace handle), and a second pivot member. The brace end may include a brace configured to brace against a crown of a tooth to be cut. The second handle end opposite the brace end can be configured for gripping by a dental practitioner. The second pivot member may be located between the brace end and the second handle end, the second pivot member may be configured to mate and pivot with respect to the first second pivot member of the cutting member/tool. The second mating surface can have a shape to conform to the first mating surface of the cutting member/tool.

In one aspect, an extraction device can include a cutting member coupled with or separate from a bracing member. The cutting member can include a cutting end having a cutting edge configured to fit between roots of a multi-rooted tooth and to cut the tooth from root to crown. The cutting member can also include a first handle end opposite the cutting end, and the handle can include a grip configured to be gripped by a practitioner. A first pivot member of the cutting member can be located between the cutting end and the first handle end. The bracing member can be configured to be removably coupleable with the cutting member at a pivoting axis, and to pivot at the pivoting axis with respect to the cutting member when coupled thereto such that the cutting member and bracing member form an open orientation and a closed orientation. The open orientation may include the cutting end being separated from the bracing end while the handle of the cutting member is separated from the handle of the bracing member. The open orientation may resemble an “X” in shape. The closed orientation may include the cutting end being adjacent to or in contact with the bracing end while the handles of cutting and bracing members are also adjacent or in contact. The transition from the open orientation to the closed orientation can facilitate cutting the tooth from root to crown. The bracing member can include a brace end having a tooth brace configured to brace a crown of the tooth when the bracing member is coupled to the cutting member in the open orientation with the cutting end inserted between the roots. When in the closed orientation the brace end can receive the cutting end. The bracing member can include a second handle end (e.g., brace handle) opposite the brace end, and the brace handle can include a grip configured to be gripped by the practitioner. Also, the brace handle can be configured to receive the first handle end of the cutting member when in the closed orientation. The second pivot member of the bracing member can be configured to mate with the first pivot member of the cutting member so as to removably couple the bracing member with the cutting member and allow the cutting member to pivot with respect to the bracing member.

The cutting member/tool and bracing member/tool can be used in a method of extracting a multi-rooted tooth. Such a method can include: providing a multi-rooted tooth extraction device that includes a cutting member and a bracing member; inserting the cutting member between roots of a multi-rooted tooth; coupling the bracing member with the cutting member; bracing the bracing member against a crown of the tooth; and cutting the tooth with the cutting member from the root to the crown. This can split the tooth into two pieces for easy withdrawal from the tooth socket, and each piece can be extracted similar to the less invasive simple root extraction technique.

Extraction Device

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein. All embodiments and components and features illustrated in the figures and/or described herein can be applied to other embodiments of the extraction device and methods of using the same.

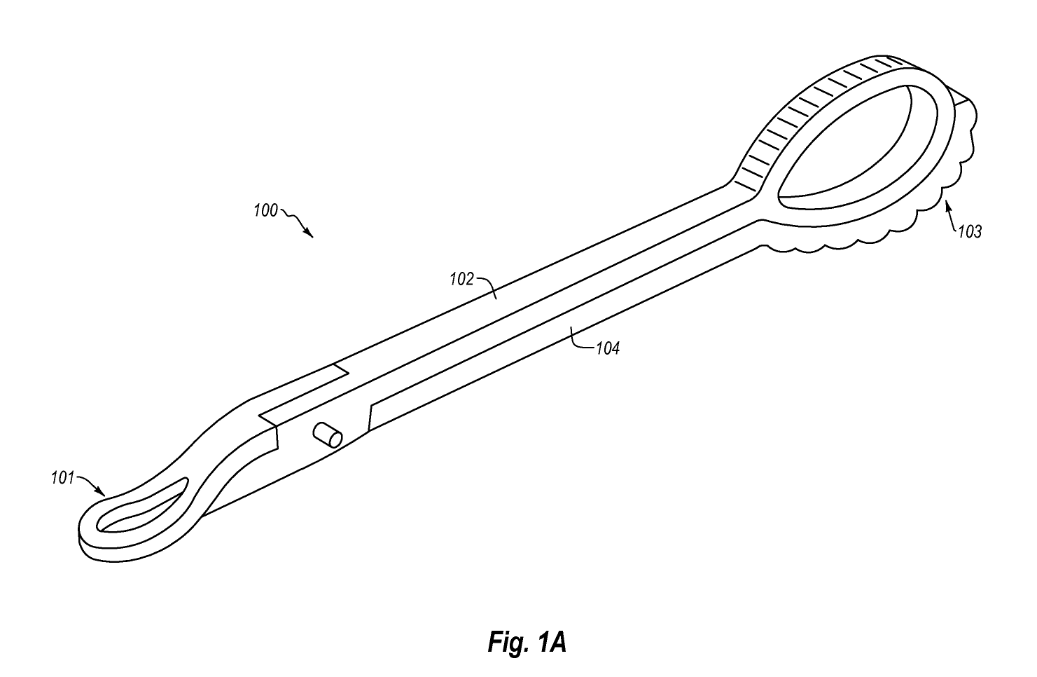

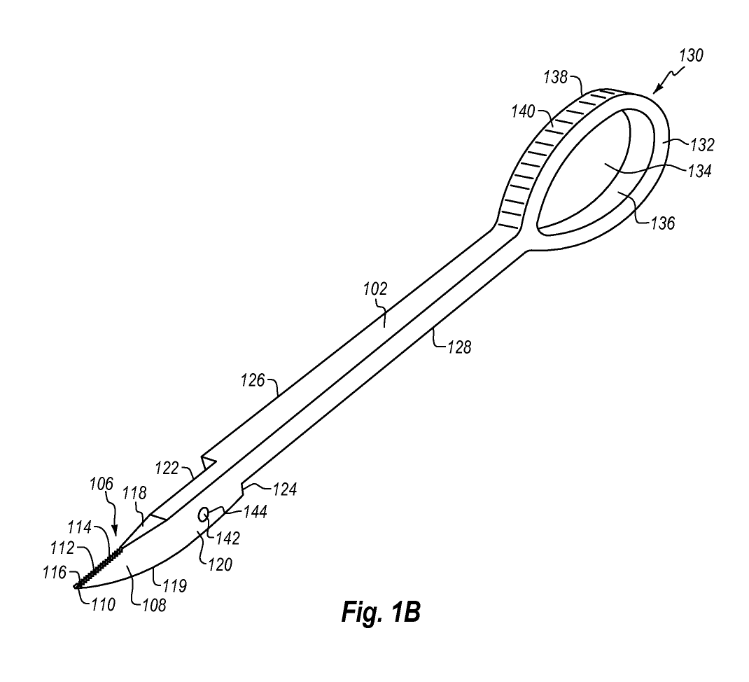

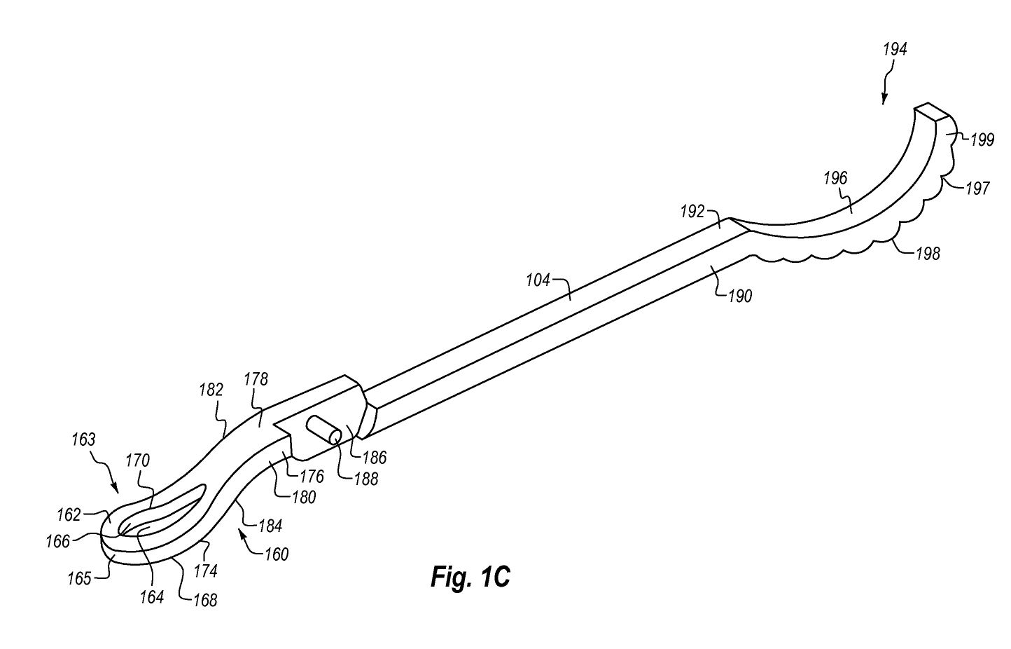

FIG. 1A is an illustration of an embodiment of a multi-rooted tooth extraction device 100. The extraction device 100 may include a cutting tool 102 and a bracing tool 104. The extraction device may include a cutting end 101 and a handle end 103. As shown, the cutting tool 102 and bracing tool 104 are designed to fit together with surfaces that conform with surfaces of the other tool.

FIG. 1B is an illustration of an embodiment of a cutting tool 102 that can couple with a bracing tool 104 (see FIG. 1C) to form the extraction device 100 of FIG. 1A. The cutting tool 102 may include a cutting end 106 that has a cutting segment 108 that includes a tip 110 and a cutting blade 112. The cutting blade 112 can have a serrated cutting edge 114 and the tip 110 can include a serrate point 116 or other sharp tip. The cutting edge 114 can be on a side of the cutting tool 102 that is considered to be a tooth-facing side. The cutting end 108 can also include a flat portion 119 close to the cutting blade 112 and on the tooth-facing side, where the flat portion 119 can be of a sufficient dimension to allow a finger of a dental practitioner to be positioned on the flat portion 119 so that pressure can be applied during penetration of the tip 110 through tissue. The cutting end 108 can include a blunt surface 119 (e.g., not sharp or non-cutting) that is opposite of the cutting blade 112 such that the blunt surface is on a tissue-facing side of the cutting end 108. The cutting end 108 may also include a first blade side 120 and a second blade side 122 that is opposite the first blade surface 120, where these surfaces can be on each side of the cutting blade 112 and blunt surface 119. The cutting end 108 can also include a back surface 124 that is configured to be shaped to conform to a surface of the bracing tool 104. The back surface 124 may also be configured for receiving a finger of the dental practitioner to apply tooth-directed forces so that the cutting blade 112 can be positioned between the roots and adjacent to the arch between the roots.

The back surface 124 of the cutting end 106 may be coupled to or integrated with an elongate segment 126 that extends from the cutting end 106 to the handle end 130 (i.e., first handle end) of the cutting tool 102. The elongate segment 126 can include a mating surface 128 that is configured to receive and conform to a similar surface of the bracing tool 104.

The handle end 120 can be formed from a handle body 132 that defines a handle aperture 134. The handle body 132 may include an aperture defining surface 136 that may form the surface of the handle aperture 134. The handle aperture 134 may be configured to receive one or more fingers, thumbs, or hands of a dental practitioner. Additionally, the handle end 120 can include a grip 138 that can be gripped by the dental practitioner. The grip 138 can include grip members 140 that can improve gripping or handling the handle end 120. The grip members 140 can include protrusions, indentations, patterns, or other features, such as three-dimensional features, that can improve the grip and handling of the handle end 120.

The cutting tool 102 may include a pivot member 142 that can be configured as an aperture that provides for the axis of rotation or the fulcrum for the extraction device 100. The pivot member 142 can include a pivot surface 144 that defines the pivot member 142. As shown the pivot member 142 may be an aperture that extends from the first blade side 120 through the cutting tool 102 to the second blade side 120. However, the pivot member 142 can be located at any position between the cutting blade 112 and handle end 130 such that enough leverage can be obtained for performing the tooth extraction as described herein. As such, a location closer to the cutting blade 112 can allow for the elongate segment 126 to provide sufficient leverage.

FIG. 1C is an illustration of an embodiment of a bracing tool 104 that couples with the cutting tool 102 of FIG. 1B in order to form the multi-rooted extraction device 100 of FIG. 1A. The bracing tool 104 is shown to include a brace segment 160 having a brace end 162. The brace end 162 is shown to include a blade receiving aperture 164, which can receive the cutting blade 112 of the cutting tool 102. The blade receiving aperture 164 can be defined by an aperture surface 166. The brace end 162 may include a first lateral brace 168 and a second lateral brace 170 that may be laterally spaced from the first lateral brace 168. As shown, the first and second lateral braces 168, 170 may be arms that connect at the distal brace end 172 of the brace end 162 so as to form the blade receiving aperture 164. The blade receiving aperture 164 can also be configured to receive a crown of a tooth to be extracted so as to be a crown receiving aperture. The first and second lateral braces 168, 170 can also join together at a proximal brace end 174. The distal and proximal brace ends 172, 174 are described with orientation of the proximal brace end 174 being closer to the handle end 194, and thereby closer to the dental practitioner so as to be “proximal.” The “distal” features may be correspondingly further away from the handle and dental practitioner.

FIG. 1C shows that a neck 176 links the brace segment 162 with an elongate segment 190. The neck 176 may include a first neck surface 178 that may be oriented away from the cutting tool 102 when the bracing tool 104 is coupled therewith. The neck 176 may include a second neck surface 184 opposite the first neck surface 178 and thereby oriented toward the cutting blade 112 when the bracing tool 104 is coupled with the cutting tool 102. The neck 176 may include a first lateral neck surface 180 opposite a second lateral neck surface 182.

Proximal to the neck 176 may be a pivot member 188 which may protrude from a pivot surface 186. The pivot member 188 may be configured as a peg, axel, or the like and is configured to be received into the pivot member 142 of the cutting tool. The pivot members 142, 188 cooperate to allow for the cutting and bracing tools 102, 104 to rotate with respect to each other. Accordingly, the pivot member 188 can be at an axis of rotation. The pivot surface 186 can be smooth so that it can freely slide or rotate relative to a similar surface associated with the pivot member 142 of the cutting tool 102.

An elongate segment 190 may be proximal to the pivot member 188. The elongate segment 190 can be configured similarly to the elongate segment 126 of the cutting tool 102. As such, the elongate segment 190 can include a mating surface 192 that is configured to conform to the mating surface 128 of the cutting tool 102. The elongate segment 190 can separate the neck 176 from the handle end 194.

The handle end 194 may be opposite the bracing end 162, and can include features similar to the handle end 130 of the cutting tool 102. The handle end 194 of the bracing tool 104 may have a surface 196 that may be configured to receive the handle end 130 of the cutting tool 130. As shown, the surface 196 may have a concave arc shape that receives the oval-shaped handle end 130 of the cutting tool. Also, the handle end 194 can include a gripping surface 197 that may include grip features 199 that may be formed from protrusions 197 and troughs 198. The protrusions 197 and troughs 198 may be ergonomic features designed to receive the fingers of a dental practitioner. In an example, the gripping surface 197 can include five protrusions 197 and four troughs 198 that are ergonomically arranged to receive four fingers of the dental practitioner while the handle aperture 134 of the cutting tool 102 can receive the thumb of the dental practitioner. The handle ends 130, 194, can be configured as a handle of any type of device, such as cutting devices like scissors or shears.

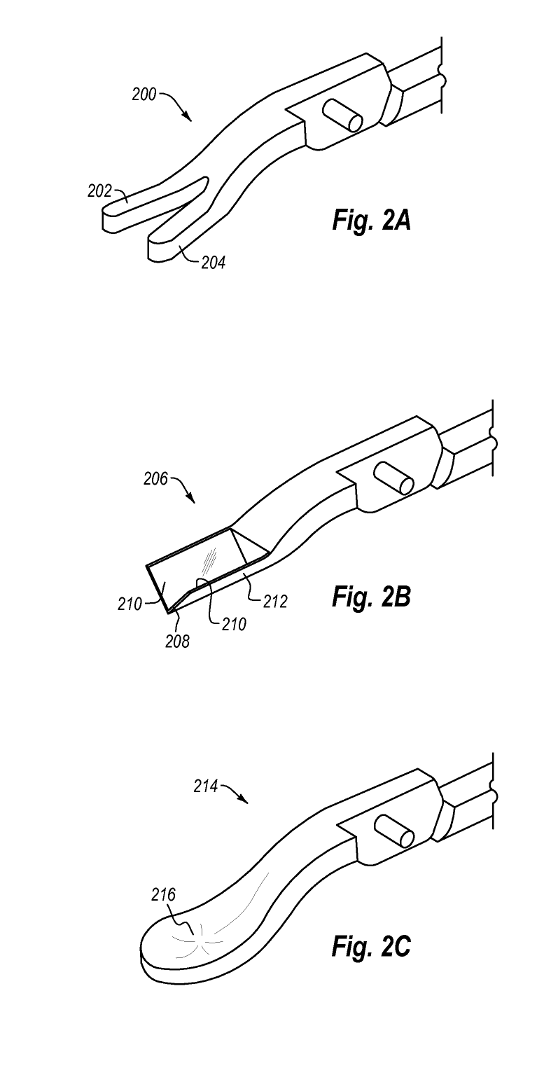

FIGS. 2A-2C are illustrations of different embodiments of brace ends 200, 206, 214 of a bracing tool 104. FIG. 1C shows a brace end that includes an aperture 164 that can be configured to receive a crown of a tooth therethrough, and thereby allow for increased leverage during the cutting and extraction procedure.

FIG. 2A shows a brace end 200 configured in a “Y” brace shape that may include a first lateral brace 202 and a second lateral brace 204. These braces 202, 204 along with the neck 176 can form the “Y” shape. The lateral braces 202, 204 can be received on opposite top edges of a crown, or shaped to be received into the trough of the crown.

FIG. 2B shows a brace end 206 configured as a “V” brace 210. The V brace 210 may include a bottom point 208 and two crown-contacting surfaces 212 that can fit into the trough of the crown.

FIG. 2C shows a brace end 214 configured as a spoon brace 216. The spoon brace 216 may be shaped similar to a spoon and can be received into the trough of the crown.

In view of the figures illustrated and described herein, an extraction device 100 can be used for improved extraction techniques for multi-rooted teeth. The extraction device 100 can include a cutting tool 102 and a bracing tool 104 that may be configured to be coupled together. The cutting tool 102 can include: a cutting end 106; a first handle end 130 opposite of the cutting end 106; and a first pivot member 142 between the cutting end 106 and the handle end 130. The cutting end 106 of the cutting tool 102 may be inserted between the roots of the tooth to be extracted. The bracing tool 104 may be coupled to the cutting tool 102 in a manner such that the bracing tool 104 braces against the crown of the multi-rooted tooth. The bracing tool 104 can include: a brace end 162; a second handle end 194 opposite of the brace end 162; and a second pivot member 188 configured to mate and pivot with the first pivot member 142. The cutting end 106 of the cutting tool can include a sharp tip 110 that can penetrate into tissue and one or more cutting edges 112. A cutting edge 112 can be located on the tooth-facing side of the cutting tool 102. Optionally, the tissue-facing side of the cutting tool may also have a cutting edge; however, the tissue-facing side may also be blunt or not sharp. The brace end 162 has a tooth brace 163 that is configured to brace against a crown of the tooth to be extracted. Such a tooth brace 163 can have one or more bracing members, such as two lateral bracing members 168, 170 that brace the edges of the crown or a single bracing member that fits into the trough of the crown.

In an embodiment, a dental tooth cutting tool 102 can include: a cutting end 106 having a sharp tip 110 and a cutting blade 112 on a tooth-facing surface and a blunt edge 119 on a tissue-facing surface opposite of the tooth-facing surface; a first handle end 130 opposite of the cutting end 106; a pivot member 142 between the cutting end 106 and the handle end 130. The pivot member 142 can be configured to mate with and couple to a pivot member 188 of a dental bracing tool 104; and a mating surface 128 having a shape to conform to a mating surface 192 of the dental bracing tool 104.

In an embodiment, a dental tooth bracing tool 104 can include: a brace end 162 having a brace 163 configured to brace against a crown of a tooth to be cut; a handle end 194 opposite of the brace end 162; a pivot member 188 between the brace end 162 and the handle end 194. The pivot member 188 can be configured to mate and pivot with a pivot member 142 of a dental tooth cutting tool 102; and a mating surface 192 having a shape to conform to a mating surface 128 of the dental tooth cutting tool 102.

Additional descriptions of the extraction device as well as the independent cutting tool and bracing tool will now be described without reference to the element numbers found in the figures. However, the terminology employed in the description can be cross-referenced with the figures. In order to facilitate extraction of a multi-rooted tooth, the cutting end of the cutting tool may be configured to fit between roots of a multi-rooted tooth. As such, the tip of the cutting end can include a sharp tip similar in design to various medical instruments that are designed to penetrate through tissue. The sharp tip may be similar to a scalpel. Various shapes can be used in forming the cutting end, such as for example a triangle, pyramid, wedge, or portion thereof, or combination thereof that can fit in between the roots of a multi-rooted tooth. Also, the cutting end can be prepared of a size that is commensurate with a dental tool and for being inserted between the roots of a multi-rooted tooth.

The cutting end can have one or more cutting edges. The primary cutting edge can be on the tooth-facing side of the cutting tool; however, the tissue-facing side may also include a cutting edge. Each cutting edge can be flat or straight as is common with knives and other blades. Alternatively, the cutting edge can be arced, where a tooth-facing cutting edge has a concave arc and a tissue-facing cutting edge can have a convex arc.

The tooth-facing cutting edge can be configured to cut the tooth from root to crown, and thereby in its orientation the tooth-facing cutting edge can cut tooth materials. A serrated blade may be used as the tooth-facing cutting edge so that a sawing motion can facilitate cutting the tooth from root to crown. Any cutting edge may or may not have a serrated edge.

In an embodiment, the cutting end can include a blade on the tooth-facing side and a blunt surface opposite of the blade. This design can allow for the sharp tip of the cutting end to penetrate the tissue and allow for the blade on the tooth-facing side to be placed against the tooth while the blunt side opposite of the blade does not further cut the tissue. The blunt side can result in less damage to the tissue or gums surrounding the roots. Also, the blunt side can provide a surface to receive a finger of a dental practitioner so that the practitioner can apply force to the blunt side that in turn applies a force from the blade to the tooth. However, a sharp surface opposite of the cutting blade may facilitate insertion of the cutting end between the roots of the tooth.

The handle of the cutting tool can allow for a dental practitioner to hold the handle to operate the device. The handle end of the cutting tool can have a grip that is configured to be gripped by a practitioner. In one configuration as shown in FIGS. 1A-1B, the handle of the cutting tool can include a body defining a grip aperture. The grip aperture can be configured to receive one or more of fingers, thumbs, hands or combinations thereof through the aperture. Also, the surface of the grip aperture can be contoured to provide ergonomic features for receiving the one or more fingers, thumbs, hands, or combinations thereof. Also, the grip can include a griping surface that includes one or more griping members to improve the grip of the handle. The gripping members can be protrusions, textures, indentations, three-dimensional patters, or other gripping members found on hand-held devices. Non-limiting examples of shapes that the grip can be prepared to have include a circle, oval, triangle, square, rectangle, polygon, or derivative thereof, or portion thereof, or combination thereof

The handle end of the cutting tool is separated from the cutting end by an elongate segment. The elongate segment can be sufficiently rigid to prevent flexing, deformation, or bending that inhibits the cutting tool from cutting of a tooth with the cutting end. The elongate segment may have a sufficient length to provide sufficient leverage to allow cutting of the tooth with the cutting end. The elongate segment can have a cross-sectional profile that is circle, oval, triangle, square, rectangle, polygon, or derivative thereof, or portion thereof, or combination thereof.

In an embodiment, the coupling of the cutting tool with the bracing tool can form a multi-rooted extraction device that has a cross-sectional profile that is circle, oval, triangle, square, rectangle, polygon, or derivative thereof, or portion thereof, or combination thereof.

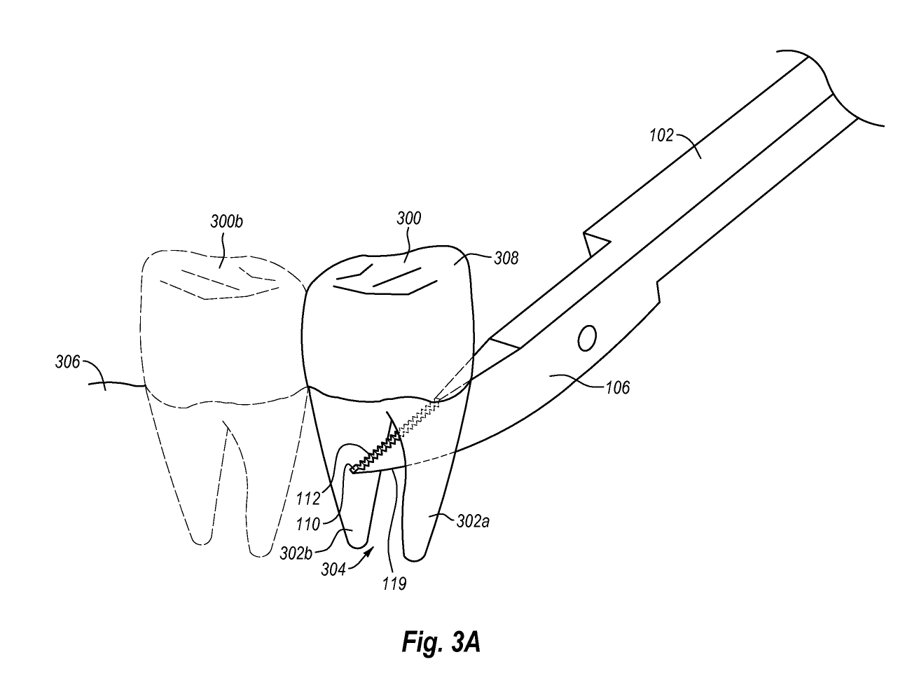

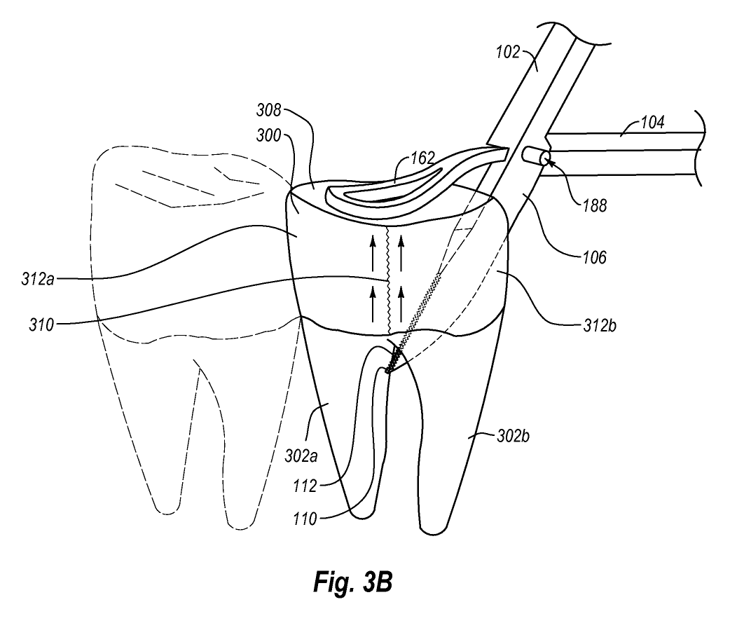

The tooth brace tool may be configured to brace the tooth when the bracing tool is coupled to the cutting tool in an open orientation with the cutting end inserted between roots or a multi-rooted tooth. FIG. 3B shows such an open orientation. The bracing tool then braces the crown of the tooth so that the cutting tool can cut the tooth from root to crown by transitioning the cutting tool and bracing tool from the open orientation to a closed orientation. FIG. 1A shows such a closed orientation. When in the closed orientation, the extraction device can have the described cross-sectional profiles. Also, when in a closed orientation, the brace end of the bracing tool can receive the cutting end of the cutting tool. For example, the brace end can include a cutting end-receiving feature, such as a recess, slot, groove, or aperture. These features can also be configured into a blade receiving feature, such as for straight blades, arced blades, serrated blades, or the like.

The tooth brace of the brace end can have various configurations and shapes. For example, the tooth brace can be configured in a loop-shape, teardrop-shape, Y-shape, V-shape, spoon-shape, or portion thereof, or combination thereof. Also, the tooth brace can include one or more lateral or distal or proximal brace members. Some examples of tooth braces are shown in FIGS. 2A-2C. Also, the tooth brace can include one or more lateral or distal or proximal brace members.

Optionally, the brace end can include a tip feature, where the tip feature can be configured for use in a dental procedure, or it can be the tip of the tooth brace. Also, the tip feature can be contoured for bracing against a multi-rooted tooth, and such a tip feature can be have a contour that matches the contour of the tooth crown. For example, the tip feature can include an aperture configured to receive a portion of the tooth crown therethrough, which can improve grip and leverage during the cutting procedure.

The bracing tool can also include a handle end that is configured to be gripped by a practitioner. Such a handle end can be considered the brace handle. The brace handle can be configured to receive the handle end of the cutting tool when in a closed orientation. Also, the brace handle end can be contoured with the handle end of the cutting member. Additionally, the brace handle can be ergonomically shaped or shaped as a common dental instrument. The brace handle can also include the grip features, grip apertures, and grip members or other features described with respect to the handle of the cutting tool.

The bracing tool can be elongate similar to the cutting tool and have the brace handle separated from the brace end by an elongate segment (i.e., second elongate segment). The second elongate segment can be configured to be sufficient rigid to prevent flexing, deformation, or bending that prevents cutting of the tooth with the cutting tool. The second elongate segment also has a sufficient length to provide sufficient leverage to allow cutting of the tooth with the cutting end. The second elongate segment can have a cross-sectional profile that is circle, oval, triangle, square, rectangle, polygon, or derivative thereof, portion thereof, or combination thereof.

The multi-rooted tooth extraction device can include the cutting tool and the bracing tool coupled together through a pivoting axis. The pivoting axis allows for the cutting tool to rotate with respect to the bracing tool, or vice versa. The cutting tool can include a first pivot member and the bracing tool can include a second pivot member, where the first pivot member and second pivot member rotate with respect to each other or rotate so that the cutting tool and bracing tool rotate with respect to each other.

In one aspect, either the first pivot member or the second pivot member can be configured as an axel that rotates with respect to an aperture of the other pivot member. The pivot members can include any common axel features. Either the first or second pivot member includes a cylindrical shape similar to a peg. The other pivot member includes a recess or aperture shaped to receive the cylindrical shape or peg. Also, the first and/or second pivot member can be configured to be received into the other pivot member.

In one aspect, the cutting tool and/or the bracing tool can include a fastener that may be configured to fasten the cutting and bracing tools together. The fastener can be located at the pivot members. For example, the fastener can include one or more of threading, bolts, nuts, screws, pressure devices, cotter pins, or combinations thereof. Also, the fastener can be configured to be unfastened. In some instances, the fastener can include a lock configured to lock the first and second pivot members together. Optionally, the lock may be capable of being unlocked.

The first and/or second pivot members, as well as the cutting tool and bracing tool can include pivoting surfaces that are configured to rotate against each other. The surfaces can be smooth and configured for smooth rotation with reduced resistance. Optionally, the surfaces can be coated with a lubricious coating, such as a polymer coating, that reduces friction between the first and second pivot members. The polymer coating can include a fluorinated polymer or a polyethylene glycol.

In an embodiment, one or more of the brace end, first handle end, or second handle end has a feature configured as a dental instrument. Non-limiting examples of the dental instrument include a dental plugger, dental condenser, dental carver, dental cleoid carver, periodontal probe, dental pick, dental hook, periodontal scaler, osteotome, or combinations thereof. Such configurations can provide the extraction device with multiple functions for dental procedures.

In an embodiment, an extraction device can include a cutting member having: a cutting end having a cutting edge configured to fit between roots of a multi-rooted tooth and cut the tooth from root to crown; a first handle end opposite of the cutting end and having a grip configured to be gripped by a practitioner; and a first pivot member between the cutting end and the handle end. The extraction device can also include a bracing member that is removably coupleable with the cutting member. The bracing member may be permanently coupled with the cutting member by the handles of each being linked together. The bracing member may be configured to brace against the crown and pivot with respect to the cutting member coupled thereto. The cutting member and bracing member can form an open orientation and a closed orientation.

The bracing member can include: a brace end having a tooth brace configured to brace a crown of the tooth when the bracing member is coupled to the cutting member in the open orientation with the cutting end inserted between the roots, when in the closed orientation the brace end receives the cutting end; a second handle end opposite of the brace end and having a grip configured to be gripped by the practitioner, the second handle end being configured to receive the first handle end when in the closed orientation; and a second pivot member configured to mate with the first pivot member so as to removably couple the bracing member with the cutting member and allow the cutting member to pivot with respect to the bracing member.

### Extraction Methods

In an embodiment, the extraction device can be used in a method of extracting a multi-rooted tooth. An example of an extraction method can include: providing a multi-rooted tooth extraction device that includes a cutting member and a bracing member; inserting the cutting member between roots of a multi-rooted member; coupling the bracing member with the cutting member; bracing the bracing member against a crown of the tooth; and cutting the tooth with the cutting member from the root to the crown.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 3A is an illustration of an embodiment of a method of inserting the cutting tool 102 of FIG. 1B between the roots 302a, 302b of a multi-rooted tooth 300. As shown, the tooth 300 can be positioned adjacent to one or more teeth 300b and is located in the gum tissue 306 of a dental patient. The tip 110 (see FIG. 1B) of the cutting tool can be inserted through the gum tissue 306 and into the tooth socket 304 with the cutting blade 112 being oriented towards the tooth 300. As shown, the blunt surface 119 opposite of the cutting blade 112 can be oriented towards the tissue 306 and socket 304. The cutting blade 112 can be positioned in the socket 304 between the roots 302a, 302b of the multi-rooted tooth 300 and adjacent to the tooth 300. Once the cutting blade 112 is in position, the bracing tool 104 can be coupled to the cutting tool 102 as described herein.

FIG. 3B is an illustration of an embodiment of a method of coupling the bracing tool 104 of FIG. 1B with the cutting tool 102 of FIG. 1C to form the multi-rooted tooth extraction device 100 of FIG. 1A and to cut the tooth 300 of FIG. 3A and split the tooth 300 from root 302a, 302b to crown 308. As shown, the cutting blade 112 cuts through the tooth 300 as shown by the arrows and forming a first tooth fragment 312a and a second tooth fragment 312b. The cutting path 310 is shown as the line from root 302a, 302b to crown 308. After the tooth 300 has been bisected, it can be removed by standard dental procedures.

The insertion of the cutting tool into the tissue surrounding the roots can be facilitated with the sharp tip designed to puncture through tissue. Also, standard techniques can be employed to insert the tip through the tissue with minimal invasiveness. In some instances, the blade configuration can modulate the procedure for cutting the tooth. For example, in instance the cutting edge is a serrated cutting blade, a sawing motion can be performed by hand. The practitioner can use one or two hands to grip the handles to apply enough pressure that a sawing motion can cut through the tooth. Also, it may be possible that a straight or flat cutting edge can slice through the tooth upon application of sufficient pressure. In one aspect, the cutting edge can be arced to improve insertion around the crown of the tooth and between the roots, which can be obtained with a concave cutting blade.

After the cutting tool is sufficiently placed between the roots of the tooth, the first pivot member of the cutting tool can be coupled with the second pivoting member of the bracing tool. Before, during, or after the coupling, the brace end can be fit onto the crown of the tooth to be extracted. When the cutting and bracing tools are sufficiently positioned and coupled together, the cutting member can be rotated towards the bracing member. The rotation of one member towards another can be considered to also include situations where the either of the members are rotating or being held in place and that there is rotation of one member with respect to the other member.

Eventually, the cutting tool breaks through the crown and splits the tooth into two or more pieces. Clean cuts can result in two single rooted fragments that can be easily removed with the simple extraction method. Any standard technique can be used for removing a tooth fragment from its socket.

### Manufacturing

The extraction device, cutting tool, and/or bracing tool can include the cutting end, bracing end, elongate shaft, and handles can be metal, such as stainless steel, aluminum, galvanized steel, titanium, or other commonly used material for surgical and/or dental instruments such as ceramics or composite materials. Examples of metals can include stainless steel, silver, platinum, tantalum, palladium, cobalt-chromium alloys, or other known biocompatible metal materials. The handle may also be prepared from the same or different metal as well as polymers, ceramics, or composites. Also, the handle can be polymeric, and may not be a biocompatible material.

Examples of some ceramic materials that can be prepared into the extraction device, cutting tool, and/or bracing tool include, but are not limited to, aluminum oxides, zirconia, carbides, borides, nitrides, or silicides. Examples of composites include, but are not limited to, woven wire with fiber metal felt and composite materials formed from polymers, metals, and/or ceramics.

The handles can be prepared from various materials, such as, but not limited to, metals and alloys, polymers, biostable polymers, ceramics, and composites. Examples of such polymers include, but are not limited to, polyvinylidene difluoride (PVDF), polyethylene, polypropylene, polytetrafluoroethylene (PTFE), or polycarbonates.

The extraction device, cutting tool, and/or bracing tool can be formed from a ceramic material. In one aspect, the ceramic can be a biocompatible ceramic. Examples of suitable ceramic materials include, but are not limited to, hydroxylapatite, mullite, crystalline oxides, non-crystalline oxides, carbides, nitrides, silicides, borides, phosphides, sulfides, tellurides, selenides, aluminum oxide, silicon oxide, titanium oxide, zirconium oxide, alumina-zirconia, silicon carbide, titanium carbide, titanium boride, aluminum nitride, silicon nitride, ferrites, iron sulfide, and the like.

Moreover, the cutting end can include a radiopaque material to increase visibility using a machine. Radiopaque materials can be viewed by a variety of techniques. Optionally, the radiopaque material can be a layer or coating on a portion (or the entirety) of the cutting end. The radiopaque materials can include, but are not limited to, platinum, tungsten, silver, stainless steel, gold, tantalum, bismuth, barium sulfate, or a similar material.

It is further contemplated that the external surface of the extraction device, cutting tool, and/or bracing tool can be coated with another material having a composition different from the primary implant material. The use of a different material to coat the surfaces can be beneficial for imparting additional properties, such as biocompatibility. Also, a coating on the cutting end can include beneficial agents embedded therein.

The coating on the cutting edge can facilitate the loading or delivery of beneficial agents or drugs, such as but not limited to therapeutic agents, pharmaceuticals and radiation therapies. The drug or beneficial agent can be useful to improve the use of the cutting end and improve the overall extraction procedure. Such drugs or beneficial agents can include anti-inflammatories, antibiotics, antiallergic substances, radiopaque agents, hemostats, and combinations thereof. Any beneficial agent can be used.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A multi-rooted tooth extraction device comprising:
a cutting member including:
a cutting end, wherein the cutting end is used to insert between roots of a multi-rooted tooth;
a first handle end opposite of the cutting end; and
a first pivot member between the cutting end and the handle end; and
a bracing member that is removably coupleable with the cutting member, the bracing member including:
a brace end;
a second handle end opposite of the brace end; and
a second pivot member configured to mate and pivot with the first pivot member.

2. The multi-rooted tooth extraction device of claim 1, wherein the cutting end comprises a cutting edge.

3-4. (canceled)

5. The multi-rooted tooth extraction device of claim 1, wherein the cutting end is configured to fit between roots of a multi-rooted tooth.

6. The multi-rooted tooth extraction device of claim 1, wherein the cutting end is configured to cut a tooth from a root to a crown.

7-9. (canceled)

10. The multi-rooted tooth extraction device of claim 1, wherein the cutting end comprises a blade and a blunt surface opposite the blade, and wherein the blunt surface is configured to receive a finger of a practitioner and to apply pressure during cutting with the blade.

11. The multi-rooted tooth extraction device of claim 1, wherein the cutting end is shaped as at least one of a triangle, a pyramid, a wedge, or a combination thereof.

12. (canceled)

13. The multi-rooted tooth extraction device of claim 1, wherein the first handle end comprises a grip.

14. (canceled)

15. The multi-rooted tooth extraction device of claim 13, wherein the grip comprises a surface having at least one gripping member.

16-17. (canceled)

18. The multi-rooted tooth extraction device of claim 1, wherein the first handle comprises a body defining a grip aperture.

19-24. (canceled)

25. The multi-rooted tooth extraction device of claim 1, wherein the first pivot member is configured to rotate with respect to the second pivot member.

26-28. (canceled)

29. The multi-rooted tooth extraction device of claim 1, further comprising:
a fastener configured to fasten the cutting member and the bracing member together.

30-31. (canceled)

32. The multi-rooted tooth extraction device of claim 1, further comprising:
a lock configured to lock the first pivot member and the second pivot member together.

33-35. (canceled)

36. The multi-rooted tooth extraction device of claim 1, wherein the brace end comprises a tooth brace.

37. The multi-rooted tooth extraction device of claim 36, wherein the tooth brace is configured to brace a crown of a tooth.

38. (canceled)

39. The multi-rooted tooth extraction device of claim 36, wherein the tooth brace is configured to brace a tooth when the bracing member is coupled to the cutting member in an open orientation with the cutting end inserted between roots of a multi-rooted tooth.

40. (canceled)

41. The multi-rooted tooth extraction device of claim 36, wherein the tooth brace is configured in at least one of a loop-shape, a teardrop-shape, a Y-shape, a V-shape, a spoon-shape, or a combination thereof

42-69. (canceled)

70. A multi-rooted tooth extraction device comprising:
a cutting member including:
a cutting end having a cutting edge configured to fit between roots of a multi-rooted tooth and cut the tooth from root to crown;
a first handle end opposite the cutting end and having a first grip configured to be gripped by a practitioner; and
a first pivot member between the cutting end and the handle end; and
a bracing member that is removably coupleable with the cutting member and is configured to pivot with respect to the cutting member coupled thereto such that the cutting member and the bracing member are configured to form an open orientation and a closed orientation, the bracing member including:
a brace end having a tooth brace configured to brace a crown of the tooth when the bracing member is coupled to the cutting member in the open orientation with the cutting end inserted between the roots, wherein the brace end is configured to receive the cutting end in the closed orientation;
a second handle end opposite the brace end and having a second grip configured to be gripped by the practitioner, the second handle end being configured to receive the first handle end when in the closed orientation; and
a second pivot member configured to mate with the first pivot member so as to removably couple the bracing member with the cutting member and allow the cutting member to pivot with respect to the bracing member.

71. A method of extracting a multi-rooted tooth, the method comprising:
providing a multi-rooted tooth extraction device that includes a cutting member and a bracing member;
inserting the cutting member between roots of the multi-rooted tooth;
coupling the bracing member with the cutting member;
bracing the bracing member against a crown of the multi-rooted tooth; and
cutting the multi-rooted tooth with the cutting member from between the roots to the crown.

72-79. (canceled)

80. A dental tooth cutting tool comprising:
a cutting end having a sharp tip and a cutting blade on a tooth-facing surface and a blunt edge on a tissue-facing surface opposite the tooth-facing surface, wherein the cutting end is configured to fit between roots of a multi-rooted tooth;
a first handle end opposite of the cutting end;
a first pivot member between the cutting end and the handle end, the first pivot member being configured to mate with and couple to a second pivot member of a dental bracing tool; and
a first mating surface having a shape conforming to a second mating surface of the dental bracing tool.

81-82. (canceled)

83. The dental tooth cutting tool of claim 80, wherein the cutting end comprises a serrated blade.

84. (canceled)

85. The dental tooth cutting tool of claim 80, wherein the cutting edge is at least one of flat or straight.

86. The dental tooth cutting tool of claim 80, wherein the cutting edge is arced.

87. A dental tooth bracing tool comprising:
a brace end having a brace member configured to brace against a crown of a tooth to be cut from the top of the crown;
a handle end opposite of the brace end; and
a first pivot member between the brace end and the handle end, the first pivot member configured to mate and pivot with a second pivot member of a dental tooth cutting tool; and
a first mating surface having a shape conforming to a second mating surface of the dental tooth cutting tool.

88-91. (canceled)

92. The dental tooth bracing tool of claim 87, wherein the brace end comprises at least one of a lateral brace member, a distal brace member or a proximal brace member.

93-95. (canceled)
